(19) United States
(12) Patent Application Publication
(10) Pub. No.: US 2021/0246697 A1
(43) Pub. Date: Aug. 12, 2021

(54) MOUNTING BRACKET FOR AN INVERTED CONSTANT FORCE WINDOW BALANCE

(71) Applicant: Amesbury Group, Inc., Edina, MN (US)

(72) Inventor: Wilbur J. Kellum, Garretson, SD (US)

(21) Appl. No.: 17/170,898

(22) Filed: Feb. 9, 2021

Related U.S. Application Data
(60) Provisional application No. 62/972,956, filed on Feb. 11, 2020.

(51) Int. Cl. E05D 13/00

(52) U.S. Cl. CPC E05D 13/1276

(57) ABSTRACT

A mounting bracket for an inverted constant force window balance system includes a jamb mount configured to be secured to a window jamb and adapted to be releasably secured to a coil spring housing of the inverted constant force window balance system. The mounting bracket also includes a coil spring mount having a body with a back wall slidably engaged with the jamb mount and a cage extending from the back wall adapted to secure a free end of a coil spring disposed at least partially within the coil spring housing. The cage includes a front wall opposite the back wall and is configured to be positioned adjacent the window jamb. A thickness of the front wall is greater than a thickness of the back wall.

### CROSS-REFERENCE TO RELATED APPLICATIONS

This application claims priority to and the benefit of U.S. Provisional Application No. 62/972,956, filed Feb. 11, 2020, which is incorporated by reference herein in its entirety.

### BACKGROUND

Sash windows assemblies include one or more moveable panels or sashes. These moveable sashes typically slide within or along a window jamb and may include one or more balance assemblies or systems mounted within the space between the sash and the jamb to assist with the sliding movement of the sash. Some known sash window assemblies allow for the sash to pivot relative to the jamb such that the sash may be tilted inwards for cleaning and/or installation/removal purposes. As such, the balance systems may include a carrier assembly that holds in place within the window jamb to prevent retraction of the balance system due to the titled and/or removed sash.

At least some known inverted constant force window balance systems include a carrier assembly that is coupled to the window sash through a pivot bar. The carrier assembly carries a coil spring having a free end secured to a window jamb channel with a mounting bracket, screw, or other element. As the coil spring unwinds from the sliding movement of the sash, the recoil tendency of the spring produces a retraction force to counter the weight of the window sash. As the window sash tilts, a locking element of the carrier assembly extends outward so as to contact the jamb channel and hold the carrier assembly in place to prevent the coil spring from retracting in the absence of the weight of the sash.

### SUMMARY

In an aspect, the technology relates to a mounting bracket for an inverted constant force window balance system, the mounting bracket including: a jamb mount configured to be secured to a window jamb and adapted to be releasably secured to a coil spring housing of the inverted constant force window balance system; and a coil spring mount having a body including: a back wall slidably engaged with the jamb mount; and a cage extending from the back wall adapted to secure a free end of a coil spring disposed at least partially within the coil spring housing, wherein the cage includes a front wall opposite the back wall and configured to be positioned adjacent the window jamb, and wherein a thickness of the front wall is greater than a thickness of the back wall.

In an example, the cage further includes a pair of spaced apart side walls extending between the front wall and the back wall, and flanges are positioned at each end of the front wall and extend from a respective side wall of the pair of spaced apart side walls. In another example, the flanges extend substantially orthogonal to the respective side wall. In yet another example, each of the flanges extend approximately an equal distance from the respective side wall. In still another example, an outer surface of the flanges are coplanar with an outer surface of the front wall. In an example, the jamb mount includes: a first end having upper and lower arms shaped and sized to slidably engage the back wall; and an opposite second end having at least one oblique surface extending at least partially along a length of the jamb mount. In another example, the jamb mount includes an upper arm shaped and sized to slidably engage the back wall, the upper arm having a nose with angled walls.

In another aspect, the technology relates to a mounting bracket for an inverted constant force window balance, the mounting bracket including: a jamb mount configured to be secured to a window jamb and adapted to be releasably secured to a coil spring housing of the inverted constant force window balance; and a coil spring mount slidably engaged with the jamb mount, the coil spring mount includes a body including: a front side defining an opening shaped and sized to receive a free end of a coil spring disposed at least partially within the coil spring housing; a rear side slidably facing the jamb mount; and a pair of opposing side faces extending between the front side and the rear side, wherein each side face of the pair of side faces includes a protruding flange proximate the front side.

In an example, the front side is substantially parallel to the rear side, and a thickness of the front side is greater than a thickness of the rear side. In another example, the protruding flanges are disposed at the front side such that at least a portion of the protruding flanges define the front side. In yet another example, the pair of side faces taper towards each other in a direction from the protruding flanges toward the rear side. In still another example, a side of the protruding flanges are coplanar with the front side. In an example, the jamb mount includes: a first end having upper and lower arms shaped and sized to slidably engage the body of the coil spring mount; and an opposite second end having at least one oblique surface extending at least partially along a length of the jamb mount. In another example, the jamb mount includes an upper arm shaped and sized to slidably engage the body of the coil spring mount, the upper arm having a nose with angled walls.

In another aspect, the technology relates to an inverted constant force balance including: a housing configured to couple to a window sash, wherein the housing has a first width; a coil spring disposed at least partially within the housing, wherein a free end of the coil spring extends outside of the housing; and a mounting bracket including: a jamb mount configured to be secured to a window jamb and having a bottom extension element adapted to be releasably secured to the housing, wherein the jamb mount has a second width that is less than the first width; and a coil spring mount slidably engaged with the jamb mount and coupled to the free end of the coil spring, the coil spring mount having a body including: a back wall slidably received by the jamb mount; and a cage extending from the back wall and receiving the free end of the coil spring, wherein at least a portion of the cage has a first thickness that is greater than a second thickness of the back wall, and wherein a direction of the width of the housing and the jamb mount is substantially orthogonal to a direction of the thickness of the coil spring mount.

In an example, the housing has a third thickness, and the third thickness is greater than the first thickness of the cage. In another example, the cage has a front wall opposite the back wall, the front wall defining the first thickness. In yet another example, the front wall defines an opening for receiving the free end of the coil spring. In still another example, the cage includes one or more flanges that define the first thickness. In an example, the one or more flanges are a pair of flanges disposed on opposite sides of the cage.

### BRIEF DESCRIPTION OF THE DRAWINGS

There are shown in the drawings, examples that are presently preferred, it being understood, however, that the technology is not limited to the precise arrangements and instrumentalities shown.

FIG. 1 is a perspective view of an exemplary inverted constant force window balance system.

FIG. 2 is a plan view of a mounting bracket of the window balance system installed within a window jamb.

FIG. 3 is an exploded view of the mounting bracket.

FIG. 4 is a perspective view of a coil spring mount of the mounting bracket.

FIG. 5 is a perspective view of a jamb mount of the mounting bracket.

FIG. 6 is a plan cross-section view of the mounting bracket being installed within the window jamb.

FIG. 7 is a perspective view of another mounting bracket for use with the inverted constant force window balance system shown in FIG. 1.

FIG. 8 is a plan view of the mounting bracket shown in FIG. 7 installed within the window jamb.

FIG. 9 is a perspective view of a coil spring mount of the mounting bracket shown in FIG. 7.

FIG. 10 is another perspective view of the coil spring mount shown in FIG. 9.

### DETAILED DESCRIPTION

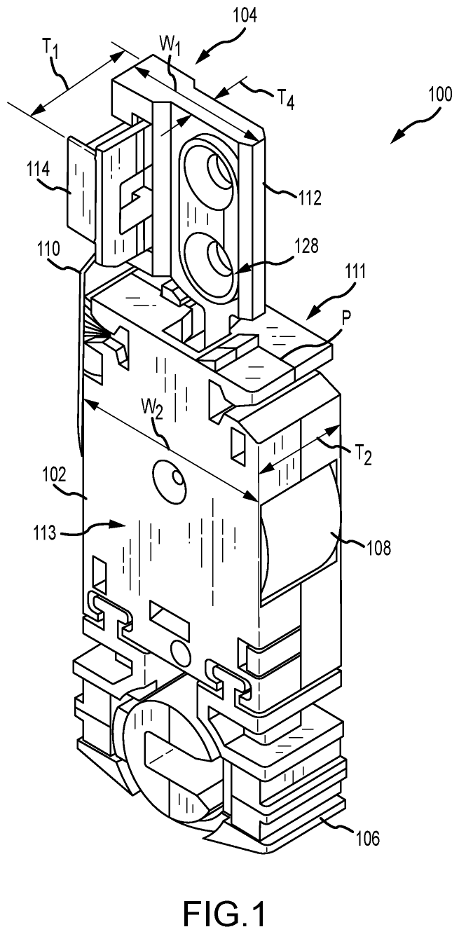

FIG. 1 is a perspective view of an exemplary inverted constant force window balance system 100. The window balance system 100 includes a housing assembly 102, a mounting bracket 104, and a shoe assembly 106. The mounting bracket 104 and the shoe assembly 106 are disposed on opposite ends of the housing assembly 102. The housing assembly 102 at least partially houses a constant force coil spring 108 that includes a free end 110 extending outside of the housing assembly 102 and coupling to the mounting bracket 104.

The mounting bracket 104 includes a jamb mount 112 and a coil spring mount 114. The coil spring mount 114 couples to the free end 110 of the coil spring 108 and the jamb mount 112 releasably couples to the top end of the housing assembly 102 while being configured to be secured to a window jamb. The jamb mount 112 can slidably move relative to both the coil spring mount 114 and the housing assembly 102 and across a plane P defined as a longitudinal cross-section of the housing assembly 102 so that the constant force window balance system 100 can be installed in either a left hand window jamb or a right hand window jamb as required or desired. For example, the jamb mount 112 is enabled to be coupled to the housing assembly 102 proximate one face surface 111 and then slide towards the other face surface 113 as required or desired for left or right hand mounting.

The housing assembly 102 is configured to couple to a window sash. For example, a pivot bar (not shown) of the window sash can be utilized to engage with the shoe assembly 106 and the window balance system 100 be used to facilitate both tilting and sliding movement of the window sash. Certain features of the inverted constant force window balance system 100 are described in detail in U.S. Patent Application Publication No. 2018/0291660 to Kellum et al., published Oct. 11, 2018, and which is hereby incorporated by reference in its entirety.

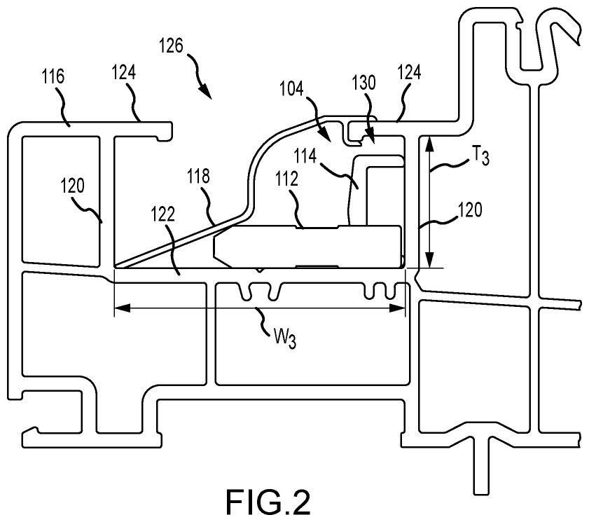

FIG. 2 is a plan view of the mounting bracket 104 of the window balance system 100 (shown in FIG. 1) installed within a window jamb 116. With continued reference to FIG. 1, the mounting bracket 104 described further below includes features that enable the mounting bracket 104 to be more easily installed into the window jamb 116 that has a jamb cover 118. A window jamb 116 is typically a substantially “C”-shaped channel with two opposing side walls 120 connected by a base wall 122. Opposite of the base wall 122, the window jamb 116 has returns 124 that extend from each side wall 120 and that define a longitudinal slot 126 allowing access into the window jamb 116. During installation of the window balance system 100 within the window jamb 116, the coil spring mount 114 is aligned against one of the side walls 120 of the jamb 116, while the jamb mount 112 is aligned against the base wall 122. The jamb mount 112 is secured to the base wall 122 via one or more fasteners (not shown) extending through one or more apertures 128. The jamb cover 118 is used to at least partially conceal the mounting bracket 104 for aesthetic and/or other purposes. However, the jamb cover 118 typically reduces the space available for the mounting bracket 104 within the window jamb 116. For example and as illustrated in FIG. 2, the jamb cover 118 extends from one return 124, across the slot 126, and towards the opposing side wall 120 adjacent the base wall 122. Accordingly, the mounting bracket 104 as described herein is shaped and sized to accommodate the jamb cover 118.

In the example, the jamb mount 112 has a width W₁ defined parallel to the plane P that is less than a width W₂ of the housing assembly 102 and less than a width W₃ of the base wall 122 of the window jamb 116. As such, the jamb mount 112 can be completely disposed behind the jamb cover 118 extending within the window jamb 116. Additionally, the coil spring mount 114 has a thickness T₁ defined orthogonal to the plane P that is less than a thickness T₂ of the housing assembly 102 and less than a thickness T₃ of the side wall 120 of the window jamb 116. As such, the coil spring mount 114 can be positioned adjacent the side wall 120 such that a gap 130 is formed between the coil spring mount 114 and the return 124 for accommodating at least a portion of the jamb cover 118. For example, some jamb covers 118 snap onto the free end of the return 124 so that the depth of the C-shaped channel (e.g., the thickness) is smaller at the free end. As such, by decreasing the thickness T₁ of the coil spring mount 114, and allowing the gap 130 to be formed within the window jamb 116, the coil spring mount 114 does not interfere with the use of the jamb cover 118. In contrast, if the thickness T₁ of the coil spring mount 114 is equal to the thickness T₃ of the side wall 120, the coil spring mount 114 can undesirably interfere with the attachment of the jamb cover 118 to the window jamb 116.

As described herein, the width direction of the components of the window balance system 100 is relative to and substantially parallel to the direction of the base wall 122 of the window jamb 116, while the thickness direction of the components of the window balance system 100 is relative to and substantially parallel to the direction of the side walls 120 of the window jamb 116. Additionally, the length direction of the components of the window balance system 100 is relative to and substantially parallel to the direction that the window jamb 116 extends along (e.g., in and out of the page on FIG. 2). As such, the width, thickness, and length directions of the components of the window balance system 100 as described herein are all oriented in substantially orthogonal directions to one another. In examples, the differences between the thicknesses of the components are between approximately 1/32^{nd} of an inch and ¼^{th} of an inch. In an aspect, the difference between the thickness T₁ of the coil spring mount 114 and the thickness T₂ of the housing assembly 102 is about ⅛^{th} of an inch. Furthermore, it should be appreciated that the jamb cover 118 does not extend the length of the window jamb 116; rather, it is typically disposed only proximate the mounting bracket 104 for concealing and covering.

The jamb mount 112 has a thickness T_{4,} the thickness T₄ may vary along the width W₁ of the jamb mount 112, that is less than the thickness T₁ of the coil spring mount 114. This configuration enables the jamb mount 112 to slide completely along the thickness T₁ of the coil spring mount 114 and be oriented substantially flush with the sides of the coil spring mount 114 that define its thickness during mounting operations of the window balance system 100. The jamb mount 112 is also configured to be positioned substantially flush and directly against the base wall 122 of the window jamb 116.

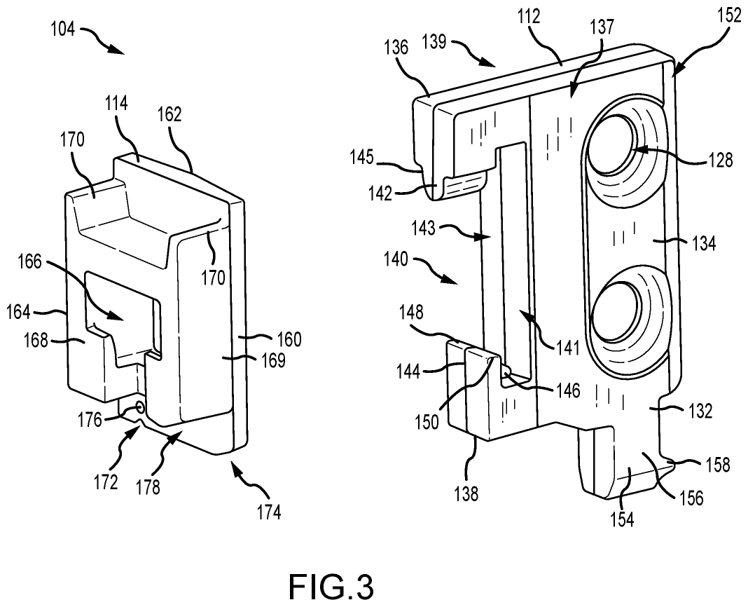

FIG. 3 is an exploded view of the mounting bracket 104. The mounting bracket 104 includes the jamb mount 112 configured to be secured to the window jamb and be releasably secured to the housing assembly 102 of the window balance system 100 (both shown in FIG. 1) and the coil spring mount 114 adapted to secure the free end 110 of the coil spring 108 (both shown in FIG. 1) disposed at least partially within the housing assembly 102. The jamb mount 112 slidably engages with the coil spring mount 114. The jamb mount 112 includes a substantially rectangular-shaped body 132 that defines at least one aperture 128 enabling a screw or other fastener element to couple the mounting bracket 104 to the window jamb. The at least one aperture 128 is surrounded by a raised collar 134 and may include a countersunk bore. On one side of the body 132, the jamb mount 112 includes a pair of upper and lower side extension arms 136, 138 for coupling the coil spring mount 114. The side extension arms 136, 138 form a channel 140 that slidably receives the coil spring mount 114 and enables the jamb mount 112 to slide in relation to the coil spring mount 114.

On the body 132, the channel 140 extends between two opposing side surfaces 137, 139 of the jamb mount 112, with each side surface 137, 139 being configured to be positioned against the window jamb. The channel 140 is formed by a first angled surface 141 disposed proximate the side surface 137 and a first orthogonal surface 143 disposed proximate the side surface 139. The orthogonal surface 143 is oriented substantially orthogonal relative to the side surfaces 137, 139, while the angled surface 141 is oriented obliquely relative to the side surfaces 137, 139. In an aspect, the angled surface 141 and the orthogonal surface 143 each are about one-half of the thickness of the body 132.

The upper side extension arm 136 includes an upper nose 142 and the lower side extension arm 138 includes a lower nose 144. The lower nose 144 can include two angled walls 145 that taper inwardly and towards each other in a downward direction. Additionally, the lower side extension arm 138 includes a detent 146 disposed within the channel 140. Both the upper nose 142 and the lower nose 144 have a second angled surface 148 disposed proximate the side surface 139 and a second orthogonal surface 150 disposed proximate the side surface 137 that form the channel 140. The orthogonal surface 150 is oriented substantially orthogonal relative to the side surfaces 137, 139, while the angled surface 148 is oriented obliquely relative to the side surfaces 137, 139. In an aspect, the angled surface 148 and the orthogonal surface 150 each are about one-half of the thickness of the body 132. The first angled surface 141 on the body 132 is positioned opposite of the second orthogonal surface 150 on the noses 142, 144 and the first orthogonal surface 143 on the body 132 is positioned opposite the second angled surface 148 on the noses 142, 144. As such, the angled surfaces 141 and 148 are across from one another with respect to the channel 140.

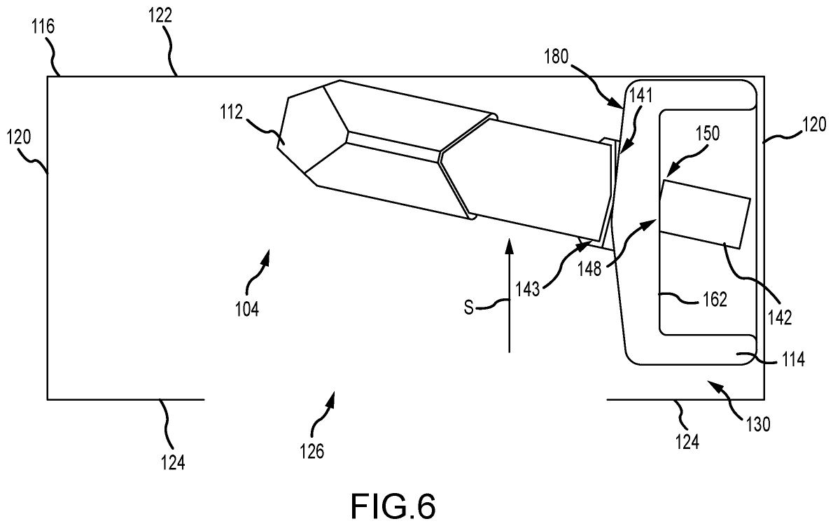

The angled surfaces 141, 148 and the orthogonal surfaces 143, 150 facilitate articulation of the jamb mount 112 when sliding across the coil spring mount 114 as described further below in reference to FIG. 6 and in retaining the jamb mount 112 in its position as illustrated in FIG. 2.

Opposite of the side extension arms 136, 138, the body 132 includes oblique surfaces 152 that extend at least partially along the length (e.g., top to bottom) of the jamb mount 112 to further reduce the size of the jamb mount 112 for the jamb cover. In the example, the oblique surfaces 152 are disposed on both side surfaces 137, 139 and taper towards each other such that the thickness of the body 132 reduces towards the end. Additionally, the jamb mount 112 includes a bottom extension element 154 extending from the bottom of the body 132. The bottom extension element 154 includes a bottom extension arm 156 having a toe 158 extending therefrom. The bottom extension element 154 is removably received and engaged to the housing assembly 102 (shown in FIG. 1) such that the bottom extension element 154 is adapted to be releasably secured to the housing assembly 102.

The coil spring mount 114 includes a body 160 that has a back wall 162 and a cage 164 extending outwards from the back wall 162. The back wall 162 is received by the side extension arms 136, 138 of the jamb mount 112 such that the coil spring mount 114 is slidably engaged with the jamb mount 112. The cage 164 is adapted to secure the free end 110 of the coil spring 108. For example, the cage 164 includes an opening 166 defined within the body 160 to receive the free end 110 of the coil spring 108. In the example, the cage 164 includes a front wall 168 disposed opposite of the back wall 162 with the opening 166 sized and shaped to correspond to a T-shaped free end of the coil spring. As such, the free end of the coil spring may pass through the opening 166 and be positioned and secured within the cage 164 behind the front wall 168. When the mounting bracket 104 is installed in the window jamb, the front wall 168 is positioned against the window jamb so that the free end of the coil spring is secured within the cage 164.

The cage 164 includes opposing side walls 169 that are substantially flush with the back wall 162. At the top of each of the side walls 169, a side wall extension 170 is provided and the space between the two extensions 170 receives the upper nose 142 of the jamb mount 112. In an aspect, the inner surfaces of the extensions 170 are angled to correspond to the shape of the angled walls 145 of the upper nose 142. The cage 164 has a length (e.g., from top to bottom) that is smaller than the back wall 162. This configuration enables the upper and lower arms 136, 138 to be shaped and sided to slidably engage the back wall 162 and allow the jamb mount 112 to slide therealong.

At the bottom end of the back wall 162, a notch or recess 172 is defined on one side and a cutout 174 is defined on the other. In some examples, a detent 176 may also be located proximate the notch 172. The notch 172 is configured to releasably engage with the detent 146 on the jamb mount 112 so as to secure the jamb mount 112 to that side of the coil spring mount 114. However, the jamb mount 112 may be released from the notch 172 and slide over to the other side of the coil spring mount 114 as required or desired. In either position of the jamb mount 112, the upper nose 142 is contoured with the side wall extensions 170 so that the jamb mount 112 can be flush within the window jamb. The cage 164 may also include a cutout 178 that corresponds to the cutout 174 on the back wall 162, and the cutouts 174, 178 enable the coil spring mount 114 to be more efficiently coupled to the jamb mount 112. For example, be positioned between the upper and lower arms 136, 138.

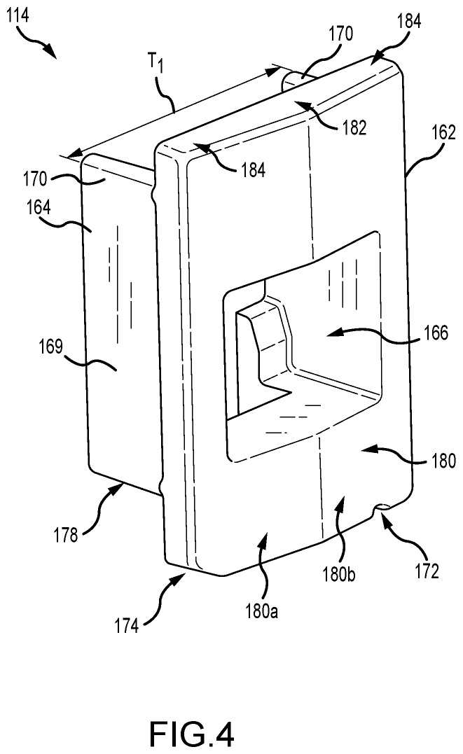

FIG. 4 is a perspective view of the coil spring mount 114 of the mounting bracket 104 (shown in FIG. 3). Certain components are described above, and thus, are not necessarily described further. In the example, the sides of the back wall 162 and the side walls 169 of the cage 164 are substantially flush with one another, thereby, defining the thickness T₁ of the coil spring mount 114. Additionally, an outer surface 180 of the back wall 162 that is opposite of the cage 164 may taper with two oblique surfaces 180a, 180b. In another aspect, the outer surface 180 may be curved with two curved surfaces. A center portion 182 of the back wall 162 is larger than side portions 184 such that each surface 180a, 180b slopes either linearly or curved from a high point proximate the center 182 towards a low point proximate the sides 184. If the outer surface 180 is curved, the apex of the curve may be at the center portion 182, while if the outer surface 180 includes oblique surfaces, the oblique surfaces may be substantially angled away from the center portion 182. As illustrated in FIG. 4, the surfaces 180a, 180b can have similar angles/curves and be mirror images of each other. This configuration assists in both retaining the jamb mount 112 (shown in FIG. 3) to one side of the coil spring mount 114 as illustrated in FIG. 2 and also sliding the jamb mount 112 towards the other side of the coil spring mount 114 as illustrated in FIG. 6 and described further below.

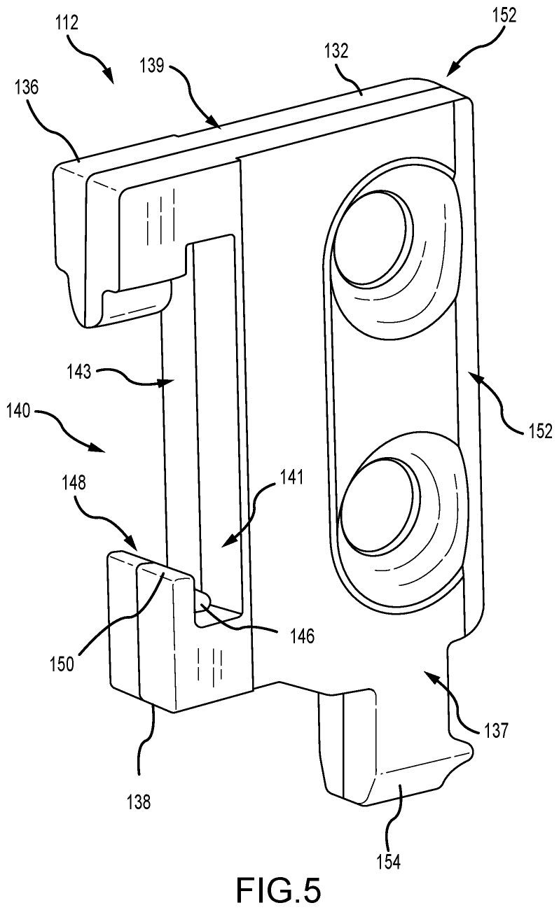

FIG. 5 is a perspective view of the jamb mount 112 of the mounting bracket 104 (shown in FIG. 3). Certain components are described above, and thus, are not necessarily described further. In the example, one end of the body 132 has the upper and lower arms 136, 138 extending therefrom to define the channel 140 for at least partially receiving the back wall 162 of the coil spring mount 114 (both shown in FIG. 4). The angled surfaces 141, 148 are on opposite sides from one another and the first angled surface 141 is shaped to correspond to the outer surface 180 of the back wall 162 (both shown in FIG. 4). The other end of the body 132 has the oblique surfaces 152. In other examples, this end of the body 132 may be at least partially rounded as required or desired.

FIG. 6 is a plan cross-sectional view of the mounting bracket 104 being installed within the window jamb 116. Certain components are described above, and thus, are not necessarily described further. In contrast to FIG. 2, the window jamb 116 illustrated in FIG. 6 is positioned on the other side of the window sash. That is, the longitudinal slots 126 and the returns 124 of each window jamb 116 face each other with the window sash therebetween. The jamb cover 118 (shown in FIG. 2) is not shown for clarity, but the mounting bracket 104 forms the gap 130 and will not interfere with the jamb cover. As such, to install the mounting bracket 104 into this window jamb 116 and secure the jamb mount 112 against the base wall 122, the jamb mount 112 slides S relative to the coil spring mount 114 and the housing assembly 102 (shown in FIG. 1). This sliding direction S is substantially parallel to the channel side walls 120 and the thickness of the coil spring mount 114, while being substantially orthogonal to the channel base wall 122.

When the jamb mount 112 is disposed on the side of the coil spring mount 114 proximate the return 124, the orthogonal surface 150 is positioned against the inner side of the back wall 162, while the angled surface 141 is positioned against the outer surface 180 of the back wall 162. This position facilities retaining the jamb mount 112 position on the coil spring mount 114 because the surface 180 tapers outward in the direction of movement of the jamb mount 112 along the coil spring mount 114. However, force can be applied to the jamb mount 112 to facilitate sliding movement as required or desired.

In an aspect, the sliding movement S of the jamb mount 112 is induced by a fastener (not shown) being inserted into one or more of the apertures 128 (shown in FIG. 3) and fastened to the base wall 122 of the window jamb 116. Because the apertures 128 are on one end of the jamb mount 112, the forces that induce the sliding movement are on one end of the jamb mount 112 and opposite of the extension arms engaged with the coil spring mount 114. As such, to facilitate the jamb mount 112 sliding along the coil spring mount 114 with rotation restricted or prevented, the angled surface 141 and the orthogonal surface 143 on the body 132 and the angled surface 148 and the orthogonal surface 150 on the noses 142, 144, along with the outer surface 180 of the coil spring mount 114, all corporate to enable a smoother sliding transition of the jamb mount 112 along the coil spring mount 114. For example, when the jamb mount 112 slides across the center portion 182 of the back wall 162, the orthogonal surface 143 is positioned against the outer surface 180, with the angled surface 148 positioned against the inner side of the back wall 162. This configuration facilitates the jamb mount 112 sliding across the coil spring mount 114 and so as to be oriented substantially flush against the base wall 122 (position shown in FIG. 2).

Additionally, when the jamb mount 112 is disposed on the side of the coil spring mount 114 proximate the base wall 122, the orthogonal surface 150 and the angled surface 141 are in opposite positions against the back wall 162. This configuration generates a bind of the jamb mount 112 with coil spring mount 114 and further facilitates retaining the jamb mount 112 position on the coil spring mount 114.

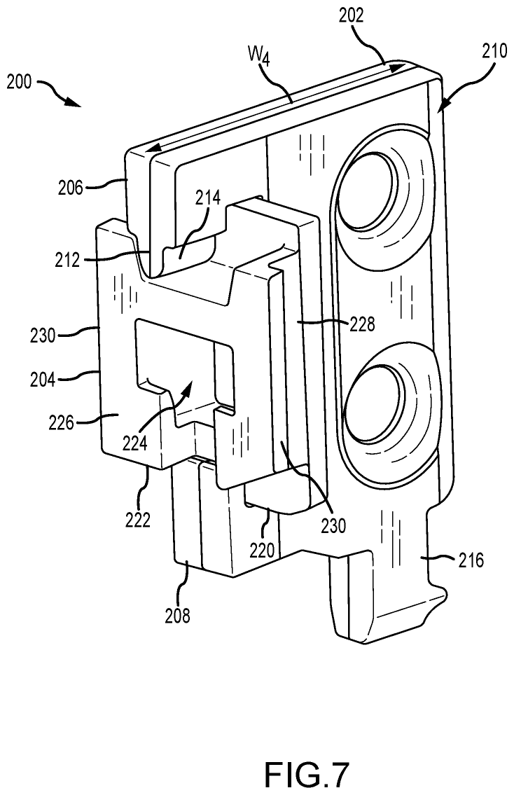

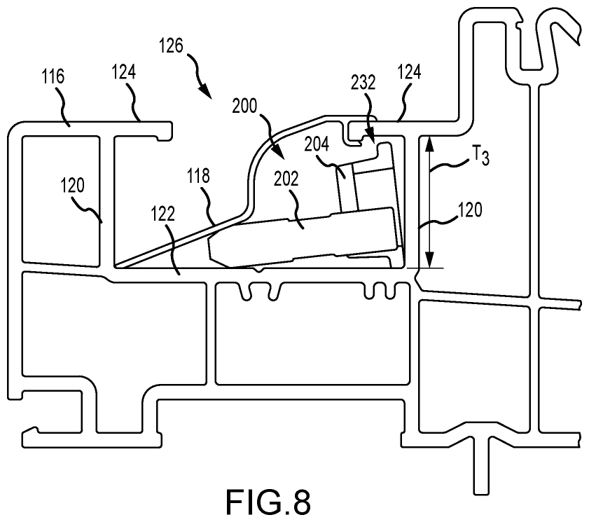

FIG. 7 is a perspective view of another mounting bracket 200 for use with the inverted constant force window balance system 100 (shown in FIG. 1). FIG. 8 is a plan view of the mounting bracket 200 installed within the window jamb 116. Referring concurrently to FIGS. 7 and 8, the mounting bracket 200 has a jamb mount 202 configured to be secured to the window jamb 116 and adapted to be releasably secured to the housing assembly 102 (shown in FIG. 1) and a coil spring mount 204 adapted to secure the free end 110 of the coil spring 108 (both shown in FIG. 1) and configured to be slidably received by the jamb mount 202.

The jamb mount 202 has many similar features to the example described above in FIGS. 1-6. For example, a first end of the jamb mount 202 has upper and lower arms 206, 208 shaped and sized to slidably engage the coil spring mount 204. An opposite second end of the jamb mount 202 has at least one oblique surface 210 extending at least partially along the length of the jamb mount 202 so that the second end decreases in thickness. A width W₄ of the jamb mount 202 from end-to-end is less than the width W₂ (shown in FIG. 1) of the housing assembly 102. The upper arm 206 has an upper nose 212 defined by angled walls 214 that correspond to portions of the coil spring mount 204. A bottom extension element 216 is adapted to be releasably secured to the housing assembly 102. In some examples, the channel defined by the arms 206, 208 and that receives the coil spring mount 204 may have orthogonal and/or angled surfaces as described above. In this example, the orthogonal and/or angled surfaces may allow for the jamb mount 202 and coil spring mount 204 to be oriented at other angles than 90° relative to one another and as described further below.

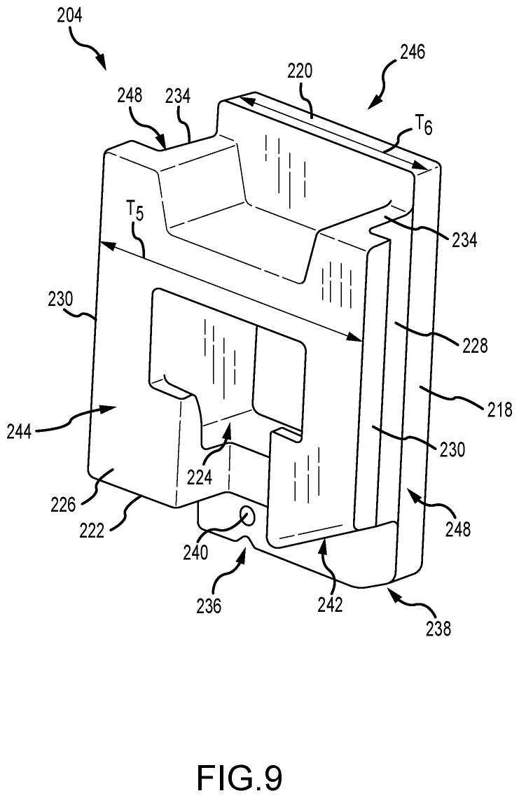

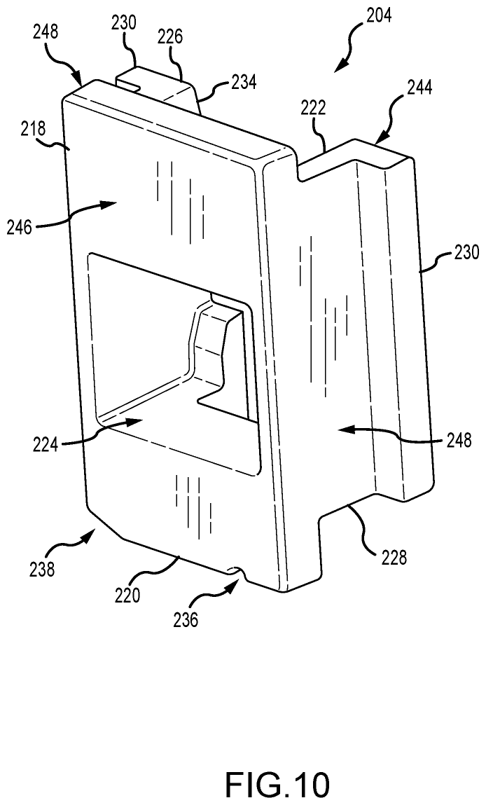

The coil spring mount 204 includes a body 218 (shown in FIGS. 9 and 10) that has a back wall 220 that slidably engages with the jamb mount 202 and a cage 222 extending outwards from the back wall 220. The cage 222 includes an opening 224 defined within the body 218 to receive the free end 110 of the coil spring 108. In this example, the cage 222 includes a front wall 226 with the opening 224 sized and shaped to corresponding to a T-shaped free end of the coil spring. The front wall 226 is configured to be positioned adjacent one of the side walls 120 of the window jamb 116. The cage 222 includes a pair of spaced apart side walls 228 that extend between the front wall 226 and the back wall 220. A flange 230 extends from each of the side walls 228 and positioned at each end of the front wall 226. As such, a thickness T₅ of the front wall 226 with the flanges 230 of the coil spring mount 204 is greater than a thickness T₆ of the back wall 220 of the coil spring mount 204 (the thickness are shown in FIG. 9). As described herein, a direction of the width W₄ of the jamb mount 202 is substantially orthogonal to a direction of the thicknesses T₅, T₆ of the coil spring mount 204.

Similar to the example described above, the mounting bracket 200 as described herein is shaped and sized to accommodate the jamb cover 118. In operation and during installation of the window balance system 100 within the window jamb 116, the front wall 226 of the coil spring mount 204 is positioned against one of the side walls 120 of the jamb 116, while the jamb mount 202 is positioned against the base wall 122 and secured thereto. The jamb cover 118 extends from one return 124, across the slot 126, and towards the opposing side wall 120 adjacent the base wall 122, and the coil spring mount 204 is sized and shaped to form a gap 232 with the return 124 so that the mounting bracket 200 and jamb cover 118 do not interfere with one another.

In the example, the jamb mount 202 has the width W₄ so that it can be completely disposed behind the jamb cover 118 extending within the window jamb 116. Additionally, the coil spring mount 204 has the thickness T₅ of the front wall 226 that is less the thickness T₃ of the side wall 120 so that the coil spring mount 204 can be positioned adjacent the side wall 120 with the gap 232 being formed. In the example, by making the front wall 226 thicker than the back wall 220, the strength of the cage 222 is increased for the securement of the coil spring and a larger surface area for the front wall 226 to engage with the window jamb 116. In an aspect, the thickness T₅ of the front wall 226 may be approximately equal to the thickness T₃ of the side wall 120 of the window jamb 116. In this example, the reduced thickness T₆ of the back wall 220 enables the gap 232 to be formed. In an aspect, each flange 230 may be approximately ⅛^{th} of an inch.

As illustrated in FIG. 8, the jamb mount 202 slides relative to the coil spring mount 204 to be substantially positioned against the window jamb 116 for securement with a fastener (not shown). The jamb mount 202 is slidable relative to the coil spring mount 204 along the back wall 220 only and its thickness T₆, rather than the thickness T₅ of the front wall 226. Thus, in this example, the jamb mount 202 does not slide completely end-to-end on the coil spring mount 204. Additionally as illustrated in FIG. 8, the jamb mount 202 is oriented substantially orthogonal in plan view relative to the coil spring mount 204, and as such, because of the flanges 230 the front wall 226, is angled relative to the side wall 120. This orthogonal orientation enables for the coil spring to be secured and for the jamb mount 202 to secure to the window jamb 116 and the window balance system to operate as described herein. In aspects, the manufacturing tolerances of the jamb mount 202 and the coil spring mount 204, enable the two components to be angled relative to each at positions other than 90° (e.g., at an obtuse angle greater than 90°). As such, the coil spring mount 204 may be substantially aligned with the side wall 120 or the window jamb 116 once the mounting bracket 200 is installed within the window jamb 116.

FIG. 9 is a perspective view of the coil spring mount 204 of the mounting bracket 200 (shown in FIG. 7). FIG. 10 is another perspective view of the coil spring mount 204. Referring concurrently to FIGS. 9 and 10, at the top of the side walls 228 of the cage 222, two sidewall extensions 234 are provided and the space therebetween slidably receives a portion of the nose 212 of the jamb mount 202 (both shown in FIG. 7). In an aspect, the inner surfaces of the sidewall extensions 234 correspond to the angled walls 214 (shown in FIG. 7) of the nose 212. In the example, the flanges 230 are aligned with the front wall 226 of the cage 222 and so that an outer surface of the flanges 230 are coplanar with an outer surface of the front wall 226. This defines the thickness T₅ of the coil spring mount 204. In an aspect, the thickness T₅ of the front wall 226 is less than or equal to the thickness T₂ of the housing assembly 102 (shown in FIG. 1). The flanges 230 are positioned on opposite sides of the cage 222 and may extend approximately an equal distance from the respective side wall 228. In an aspect, the flanges 230 are oriented substantially parallel to the front wall 226 and substantially orthogonal to the side walls 228.

At the bottom end of the back wall 220, a notch or recess 236 is defined on one side and a cutout 238 is defined on the other. In some examples, a detent 240 may also be located proximate the notch 236. The cage 222 may also include a cutout 242 that corresponds to the cutout 238 on the back wall 220. The cutouts 238, 242 facilitate easier assembly of the coil spring mount 204 to the jamb mount 202, and the notch 236 and detent 240 facilitate releasably securing the jamb mount 202 in position on the coil spring mount 204.

The body 218 of the coil spring mount 204 has a front side 244 that the opening 224 is defined and that is shaped and sized to receive the free end 110 of the coil spring 108 (both shown in FIG. 1). In an aspect, this opening 224 can extend through the back wall 220 as required or desired. The body 218 also has a rear side 246 that slidably faces the jamb mount 202 when assembled, and a pair of opposing side faces 248 that extend between the front side 244 and the rear side 246. Each of the side faces 248 include the protruding flange 230 that is disposed proximate the front side 244.

In the example, the flanges 230 are disposed at the front side 244 such that at least a portion of the flanges 230 define the front side 244. For example, a side of the flanges 230 can be coplanar with the front side 244. In an aspect, the front side 244 is substantially parallel to the rear side 246, and the front side 244 defines the thickness T₅ that is greater than the thickness T₆ of the rear side 246. In the example, the side faces 248 may not be parallel with one another and may taper inwardly towards each other in a direction from the flanges 230 toward the rear side 246. This configuration is illustrated more clearly in FIG. 8 and the plan view of the coil spring mount 204.

The materials utilized in the manufacture of the window balance components described herein may be those typically utilized for lock manufacture, e.g., zinc, steel, aluminum, brass, stainless steel, etc. Molded plastics, such as PVC, polyethylene, etc., may be utilized for the various components. Material selection for most of the components may be based on the proposed use of the window balance. Appropriate materials may be selected for window balances used on particularly heavy panels, as well as on components subject to certain environmental conditions (e.g., moisture, corrosive atmospheres, etc.).

While there have been described herein what are to be considered exemplary and preferred examples of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed:

1. A mounting bracket for an inverted constant force window balance system, the mounting bracket comprising:
a jamb mount configured to be secured to a window jamb and adapted to be releasably secured to a coil spring housing of the inverted constant force window balance system; and
a coil spring mount having a body comprising:
a back wall slidably engaged with the jamb mount; and
a cage extending from the back wall adapted to secure a free end of a coil spring disposed at least partially within the coil spring housing, wherein the cage includes a front wall opposite the back wall and configured to be positioned adjacent the window jamb, and wherein a thickness of the front wall is greater than a thickness of the back wall.

2. The mounting bracket of claim 1, wherein the cage further includes a pair of spaced apart side walls extending between the front wall and the back wall, and wherein flanges are positioned at each end of the front wall and extend from a respective side wall of the pair of spaced apart side walls.

3. The mounting bracket of claim 2, wherein the flanges extend substantially orthogonal to the respective side wall.

4. The mounting bracket of claim 2, wherein each of the flanges extend approximately an equal distance from the respective side wall.

5. The mounting bracket of claim 2, wherein an outer surface of the flanges are coplanar with an outer surface of the front wall.

6. The mounting bracket of claim 1, wherein the jamb mount comprises:
a first end having upper and lower arms shaped and sized to slidably engage the back wall; and
an opposite second end having at least one oblique surface extending at least partially along a length of the jamb mount.

7. The mounting bracket of claim 1, wherein the jamb mount comprises an upper arm shaped and sized to slidably engage the back wall, the upper arm having a nose with angled walls.

8. A mounting bracket for an inverted constant force window balance, the mounting bracket comprising:
a jamb mount configured to be secured to a window jamb and adapted to be releasably secured to a coil spring housing of the inverted constant force window balance; and
a coil spring mount slidably engaged with the jamb mount, the coil spring mount includes a body comprising:
a front side defining an opening shaped and sized to receive a free end of a coil spring disposed at least partially within the coil spring housing;
a rear side slidably facing the jamb mount; and
a pair of opposing side faces extending between the front side and the rear side, wherein each side face of the pair of side faces includes a protruding flange proximate the front side.

9. The mounting bracket of claim 8, wherein the front side is substantially parallel to the rear side, and wherein a thickness of the front side is greater than a thickness of the rear side.

10. The mounting bracket of claim 8, wherein the protruding flanges are disposed at the front side such that at least a portion of the protruding flanges define the front side.

11. The mounting bracket of claim 10, wherein the pair of side faces taper towards each other in a direction from the protruding flanges toward the rear side.

12. The mounting bracket of claim 8, wherein a side of the protruding flanges are coplanar with the front side.

13. The mounting bracket of claim 8, wherein the jamb mount comprises:
a first end having upper and lower arms shaped and sized to slidably engage the body of the coil spring mount; and
an opposite second end having at least one oblique surface extending at least partially along a length of the jamb mount.

14. The mounting bracket of claim 8, wherein the jamb mount comprises an upper arm shaped and sized to slidably engage the body of the coil spring mount, the upper arm having a nose with angled walls.

15. An inverted constant force balance comprising:
a housing configured to couple to a window sash, wherein the housing has a first width;
a coil spring disposed at least partially within the housing, wherein a free end of the coil spring extends outside of the housing; and
a mounting bracket comprising:
a jamb mount configured to be secured to a window jamb and having a bottom extension element adapted to be releasably secured to the housing, wherein the jamb mount has a second width that is less than the first width; and
a coil spring mount slidably engaged with the jamb mount and coupled to the free end of the coil spring, the coil spring mount having a body comprising:
a back wall slidably received by the jamb mount; and
a cage extending from the back wall and receiving the free end of the coil spring, wherein at least a portion of the cage has a first thickness that is greater than a second thickness of the back wall, and wherein a direction of the width of the housing and the jamb mount is substantially orthogonal to a direction of the thickness of the coil spring mount.

16. The inverted constant force balance of claim 15, wherein the housing has a third thickness, and wherein the third thickness is greater than the first thickness of the cage.

17. The inverted constant force balance of claim 15, wherein the cage has a front wall opposite the back wall, the front wall defining the first thickness.

18. The inverted constant force balance of claim 17, wherein the front wall defines an opening for receiving the free end of the coil spring.

19. The inverted constant force balance of claim 15, wherein the cage includes one or more flanges that define the first thickness.

20. The inverted constant force balance of claim 19, wherein the one or more flanges are a pair of flanges disposed on opposite sides of the cage.
